(19) United States
(12) Patent Application Publication
(10) Pub. No.: US 2012/0237006 A1
(43) Pub. Date: Sep. 20, 2012

(54) APPARATUS AND METHOD FOR PROVIDING CALLER INFORMATION

(75) Inventor: Kwang Baek KIM, Goyang-si (KR)

(73) Assignee: PANTECH CO., LTD., Seoul (KR)

(21) Appl. No.: 13/367,078

(22) Filed: Feb. 6, 2012

(30) Foreign Application Priority Data
Mar. 14, 2011 (KR) 10-2011-0022195

(51) Int. Cl. H04M 1/64

(52) U.S. Cl. 379/88.01; 379/88.11

(57) ABSTRACT

Provided are an apparatus and method for providing caller information, capable of automatically collecting identification information of a caller during a call with a caller not stored in an address book, and providing the identification information of the caller that is collected during the call to a user if the caller transmits a call again, thereby enabling the terminal user to select whether to answer the call. Accordingly, the identification information of the caller not stored in the address book is able to be collected without an additional operation performed by the terminal user, thereby enabling the terminal user to easily select whether to answer the call with the corresponding caller.

### CROSS-REFERENCE TO RELATED APPLICATION

This application claims priority to and the benefit under 35 U.S.C. §119 of Korean Patent Application No. 10-2011-0022195, filed on Mar. 14, 2011, which is incorporated by reference for all purposes as if fully set forth herein.

### BACKGROUND

1. Field

The following description relates to an apparatus and method for providing caller information, and more particularly, apparatus and method for providing caller information capable of automatically collecting and storing identification information of a caller whose identification information is not stored in an address book.

2. Discussion of the Background

One of the various services provided by a mobile terminal is a caller information providing service for, when a call is received from a caller, displaying a caller's telephone number and a name stored in an address book associated with the telephone number on a display unit of the mobile terminal.

A terminal user may determine caller information through the caller information providing service, and may select whether to answer a call from a caller.

However, the mobile terminal, according to the related art, provides a caller's telephone number and a name associated with the telephone number to a terminal user only if the telephone number exists in the address book by retrieving the address book for the caller's telephone number received from a base station, and provides the caller's telephone number received from the base station if the telephone number does not exist in the address book. Therefore, if the same telephone number as the caller's telephone number is not stored in the address book of the mobile terminal and the terminal user has no information regarding the corresponding caller's telephone number, the terminal user may not obtain any information related to the caller, other than the caller's telephone number.

### SUMMARY

Exemplary embodiments of the present invention provide apparatus and method for providing caller information, if a call is received from a caller not stored in an address book, and if a record of a call with the corresponding caller exists, capable of providing voice call data or call contents summary information stored during the previous call, thereby enabling a receiver to select whether to answer the call of the caller.

Additional features of the invention will be set forth in the description which follows, and in part will be apparent from the description, or may be learned by practice of the invention.

An exemplary embodiment of the present invention discloses an apparatus to provide caller information, the apparatus including: an address book storage unit to store telephone numbers and names received from a terminal user; a caller identification information storage unit to store a telephone number of a caller not registered in the address book storage unit, a part of contents of a call with the caller, and a keyword extracted from the call contents; a voice-text conversion unit to convert the call contents into text; a keyword extraction unit to extract the keyword by analyzing the converted text; and a control unit to control the storage of the telephone number, the call contents, and the keywords in the caller identification unit, to control the conversion of call contents to text and to control keyword extraction.

An exemplary embodiment of the present invention also discloses a method for providing caller information, the method including: determining whether a telephone number of a caller included in an incoming call is registered in an address book storage unit; if the telephone number of the caller is not registered in the address book storage unit, determining whether the telephone number of the caller is registered in a caller identification information storage unit; if the telephone number of the caller is not registered in the caller identification information storage unit, storing a caller identification information of the telephone number of the caller, a part of contents of a call with the caller, and a keyword extracted from the call contents in the caller identification information storage unit; and if the telephone number of the caller is registered in the caller identification information storage unit, displaying a keyword from the caller identification storage unit on a display unit along with the telephone number of the caller as caller information.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram of an apparatus to provide caller information according to an exemplary embodiment.

FIG. 2 is a diagram of a method for providing caller information according to an exemplary embodiment.

FIG. 3 is a diagram of a method for providing caller information according to an exemplary embodiment.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a,” “an” and “the” are intended to include the plural forms as well, unless the context clearly indicates otherwise. Furthermore, the use of the terms a, an, etc., does not denote a limitation of quantity, but rather denotes the presence of at least one of the referenced item. It will be further understood that the terms “comprises” and/or “comprising,” or “includes” and/or “including” when used in this specification, specify the presence of stated features, operations, elements, and/or components, but do not preclude the presence or addition of one or more other features, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

An apparatus and method for providing caller information, according to exemplary embodiments, will be described in detail with reference to the accompanying drawings.

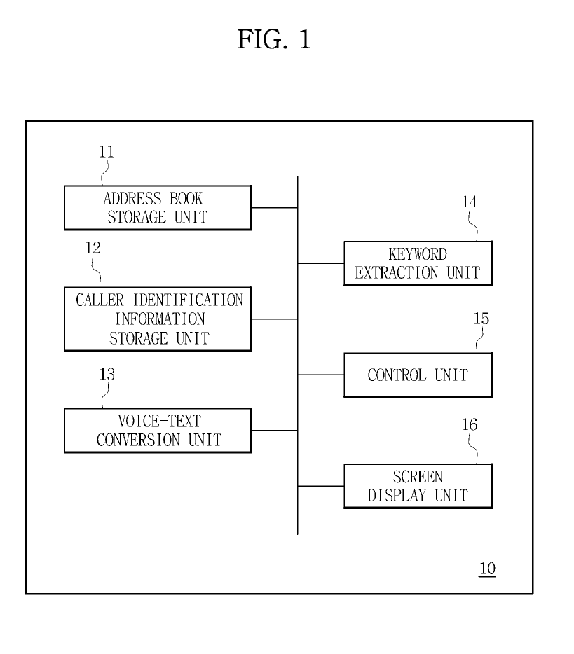

FIG. 1 is a diagram of an apparatus to provide caller information according to an exemplary embodiment.

In FIG. 1, a terminal 10 includes an address book storage unit 11, a caller identification information storage unit 12, a voice-text conversion unit 13, a keyword extraction unit 14, a control unit 15, and a display unit 16. The terminal 10 may be any telecommunication device capable of receiving telephone calls and/or text messages, e.g., a mobile phone, a smart phone, a cordless telephone, a laptop, a tablet computer, a desktop computer, etc.

In FIG. 1, an address book storage unit 11 may store telephone numbers and names input by a terminal user.

The address book storage unit 11 may store, in addition to telephone numbers (cell phone numbers, home telephone numbers, company telephone numbers, and the like), information, such as e-mail addresses, instant messengers identification, addresses, birthdays, anniversaries, images, sand memos.

A caller identification information storage unit 12 may store under the control of a control unit 15 a telephone number of a caller not registered in the address book storage unit 11, the entirety or a part of contents of a call with the corresponding caller, and keywords extracted from the call contents.

A voice-text conversion unit 13 may convert the call contents stored in the caller identification information storage unit 12 into text under the control of the control unit 15.

A keyword extraction unit 14 may extract keywords by analyzing the text converted by the voice-text conversion unit 13 under the control of the control unit 15.

The keyword extraction unit 14 may extract nouns (for example, ΔΔ bank Hong Gildong, OO insurance Yi Mongryong, or the like) positioned in front of a verb used by the caller to introduce himself/herself, and/or may extract a few important words from nouns that are frequently generated in a corresponding paragraph or from important words (place, time, telephone number, and the like) that are frequently used during the call.

If a text message is received, the keyword extraction unit 14 may analyze text included in the received text message and extract keywords under the control of the control unit 15.

The keyword extraction unit 14 may extract nouns positioned in front of an important verb or extract only nouns.

If there is an incoming call, the control unit 15 determines whether a caller's telephone number included in the incoming call is registered in the address book storage unit 11. If the caller's telephone number is registered in the address book storage unit 11, the control unit 15 reads an associated name stored in the address book storage unit 11 and displays the name on a display unit 16 as caller information.

If the caller's telephone number is not registered in the address book storage unit 11, the control unit 15 determines whether the caller's telephone number is registered in the caller identification information storage unit 12. If the caller's telephone number is not registered in the caller identification information storage unit 12, and if the terminal user answers the corresponding incoming call, the entirety or a part of contents of the call with the corresponding caller is stored in the caller identification information storage unit 12 together with the telephone number.

If the control unit 15 stores a part of the contents of the call with the caller in the caller identification information storage unit 12, the control unit 15 may extract voice data of the caller received from the caller to be stored. In order words, if a voice of the caller is received as the call starts or begins, voice data of the caller is stored, and if a voice of a receiver begins, storing the voice data of the caller is terminated. If the voice of the caller is begins again, the voice data of the caller is stored, and if the voice of the receiver begins again, storing the voice data of the caller is terminated. A specific time at the beginning of the call in which the caller generally introduces himself/herself may be stored. A part of the call contents in which specific words appear may be stored. Although described above as storing a portion of the call contents, aspects are not limited thereto such that the entire call contents may be stored, i.e., both the voice of the caller and receiver may be stored.

As described above, the control unit 15 stores the entirety or a part of the contents of the call with the corresponding caller in the caller identification information storage unit 12 together with the caller's telephone number, converts the call contents stored in the caller identification information storage unit 12 into text using the voice-text conversion unit 13, extracts keywords (for example, ΔΔ bank Hong Gildong, OO insurance Yi Mongryong, or the like) from the text converted by the voice-text conversion unit 13 using the keyword extraction unit 14, and stores the extracted keywords in the caller identification information storage unit 12 in association with the corresponding caller's telephone number.

If the caller's telephone number is registered in the caller identification information storage unit 12, the corresponding caller's telephone number and the keywords read from the caller identification information storage unit 12 using the corresponding caller's telephone number are displayed on the display unit 16 as the caller information.

If the keywords read from the caller identification information storage unit 12 are displayed on the display unit 16 along with the caller's telephone number, and the call contents stored in association with the corresponding caller's telephone number exists, the control unit 15 may reproduce the corresponding call contents instead of a ringtone as the caller information.

If the call contents stored in association with the corresponding caller's telephone number exists, the control unit 15 may reproduce the corresponding call contents unconditionally as the caller information, or may reproduce the call contents at a request of the terminal user as the caller information. In order to provide the caller information by reproducing the call contents as a ringtone at the request of the terminal user, a separate menu key that requests reproduction of the call contents may be provided.

As described above, the control unit 15 may collect identification information of a caller not registered in the address book storage unit 11 during a voice call with the caller.

The control unit 15 may collect identification information of a caller not registered in the address book storage unit 11 through a text message.

If a text message is received, the control unit 15 determines whether a caller's telephone number included in the text message is registered in the address book storage unit 11, and if the caller's telephone number is registered in the address book storage unit 11, the control unit 15 reads the name stored in the address book storage unit 11 and provides it as the caller information.

If the caller's telephone number is not registered in the address book storage unit 11, the control unit 15 determines whether the caller's telephone number is registered in the caller identification information storage unit 12. If the caller's telephone number is not registered in the caller identification information storage unit 12, the control unit 15 extracts keywords from the text included in the text message using the keyword extraction unit 14, and stores the extracted keywords in the caller identification information storage unit 12 in association with the corresponding caller's telephone number.

If the caller's telephone number is registered in the caller identification information storage unit 12, the keywords read from the caller identification information storage unit 12 using the corresponding caller's telephone number are provided as the caller information.

If the terminal user does not remember the contents of the call with the caller or wants to determine the call contents, the control unit 15 may reproduce the call contents stored in the caller identification information storage unit 12 in response to a request of the terminal user.

If the terminal user selects a telephone number of a caller not registered in the address book storage unit from a call list to determine call contents, the control unit 15 reads keywords stored in association with the selected telephone number from the caller identification information storage unit 12 to be displayed for the terminal user, and reproduces the call contents stored in the caller identification information storage unit 12 at a request of the terminal user. If the terminal user selects keywords to be reproduced, a voice data section having the selected keywords is reproduced for the terminal user.

The control unit 15 stores caller identification information in the caller identification information storage unit 12 and periodically updates the caller identification information stored in the caller identification information storage unit 12. In other words, even though a telephone number of a specific caller may be stored in the caller identification information storage unit 12, the control unit 15 periodically stores contents of a call with the corresponding caller, extracts keywords by converting the stored call contents into text, calculates weights of the extracted keywords, and if the weight of the extracted keywords is higher than the weight of previously extracted keywords, updates the contents of the call with the corresponding caller and the keywords.

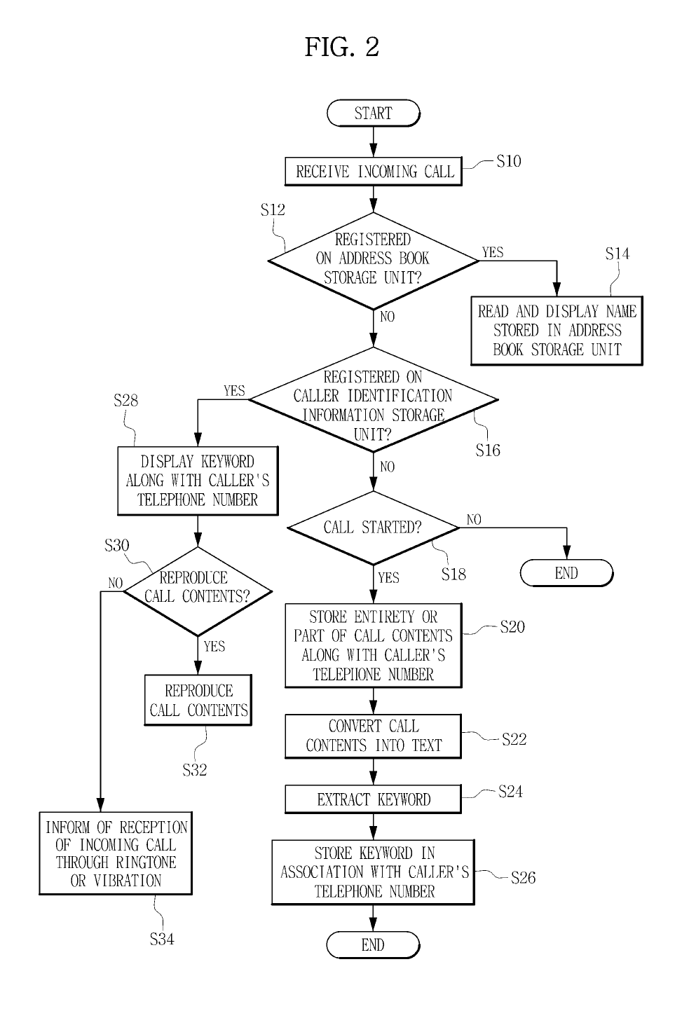

FIG. 2 is a process diagram for explaining a caller information providing method according to the embodiment.

An incoming signal is received in operation S10. A terminal 10 determines whether a caller's telephone number included in the incoming call is registered in the address book storage unit 11 in operation S12.

If the caller's telephone number is registered in the address book storage unit 11, the terminal 10 reads a name stored in association with the corresponding caller's telephone number from the address book storage unit 11, and displays the name on the display unit 16 along with the caller's telephone number as caller information for the terminal user in operation S14.

If the caller's telephone number is not registered in the address book storage unit 11, the terminal 10 determines whether the caller's telephone number is registered in the caller identification information storage unit 12 in operation S16.

If the caller's telephone number is not registered in the caller identification information storage unit 12, it is determined if the terminal user accepted the call in operation S18. If the terminal user accepts the call and starts the call, the entirety or a part of contents of the call with the caller is stored in the caller identification information storage unit 12 together with the caller's telephone number in operation S20. The call contents stored in the caller identification information storage unit 12 are converted into text using the voice-text conversion unit 13 in operation S22.

Keywords are extracted from the converted text using the keyword extraction unit 14 in operation S24. The extracted keywords are stored in the caller identification information storage unit 12 in association with the caller's telephone number in operation S26.

If the caller's telephone number is registered in the caller identification information storage unit 12, the caller's telephone number and the keywords read from the caller identification information storage unit 12 using the caller's telephone number are displayed on the display unit 16 as the caller information in operation S28.

In operation S30, the terminal 10 determines whether the call contents are set to be reproduced or whether a request to reproduce the call contents instead of a ringtone is received from the terminal user.

If the call contents are set to be reproduced or the request to reproduce the call contents as a ringtone is received from the terminal user, the terminal 10 reproduces the call contents stored or reproduces the call contents as the ringtone in association with the corresponding caller's telephone number as the caller information in operation S32.

If the call contents are not set to be reproduced or the request to reproduce the call contents as a ringtone is not received from the terminal user, the terminal user is informed of reception of the incoming signal through a ringtone or vibration in operation S34.

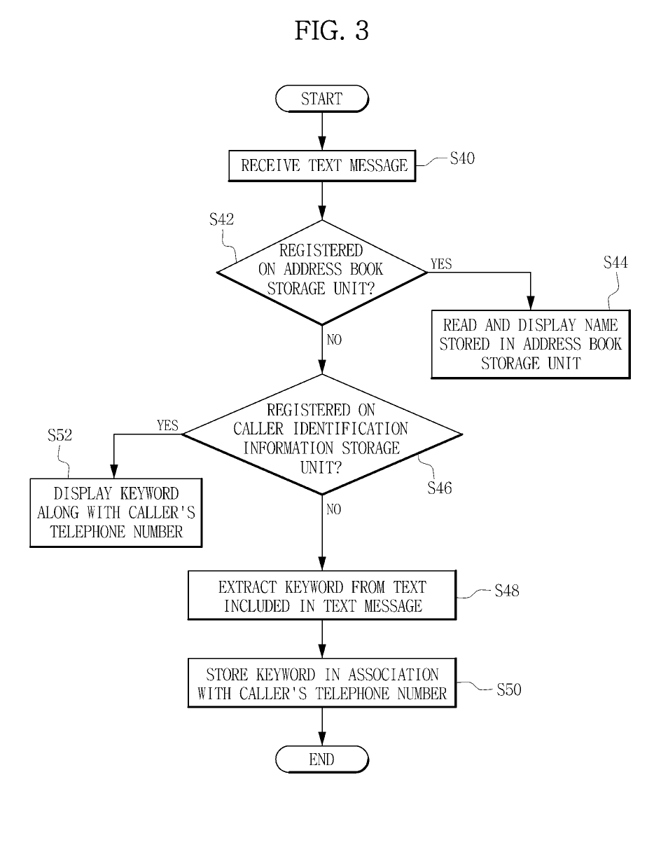

FIG. 3 is a diagram of a method for providing caller information according to an exemplary embodiment.

A text message is received in operation S40. The terminal 10 determines whether a caller's telephone number included in the text message is registered in the address book storage unit 11 in operation S42.

If the caller's telephone number is registered in the address book storage unit 11, the terminal 10 reads a name stored in association with the corresponding caller's telephone number from the address book storage unit 11 and provides the name as caller information in operation S44.

If the caller's telephone number is not registered in the address book storage unit 11, the terminal 10 determines whether the caller's telephone number is registered in the caller identification information storage unit 12 in operation S46.

If the caller's telephone number is not registered in the caller identification information storage unit 12, keywords are extracted from the text included in the text message in operation S48. The extracted keywords are stored in the caller identification information storage unit 12 in association with the caller's telephone number in operation S50.

If the caller's telephone number is registered in the caller identification information storage unit 12, the keywords stored in association with the corresponding caller's telephone number are read from the caller identification information storage unit 12 and are provided as the caller information in operation S52.

The terminal 10 may automatically collect identification information of callers not registered in the address book storage unit 11 through voice calls and text messages. The terminal 10 may periodically update the caller identification information stored in the caller identification information storage unit 12.

In addition, if the terminal user selects a telephone number of a caller not registered in the address book storage unit 11 from a call list to determine the call contents, the terminal 10 reads keywords stored in association with the selected caller's telephone number from the caller identification information storage unit 12 to be displayed on the display unit 16. If a reproduction request is input from the terminal user, the call contents stored in the caller identification information storage unit 12 are reproduced.

As described above, according to the apparatus and method for providing caller information of the present disclosure, identification information (telephone numbers, the entirety or a part of a call history, keywords, and the like) of callers not registered in the address book storage unit 11 are automatically collected through voice calls and text messages. If a call is received by the corresponding caller again, the identification information of the caller that was previously collected is provided for the terminal user before the terminal user answers the call, thereby enabling the terminal user to determine whether to answer the call.

The apparatus and method for providing caller information according to the present disclosure are not limited to the above-described embodiments and can be modified in various manners without departing from the spirit and scope of this disclosure.

For example, identification information of a caller that is collected through a voice call or a text message with the caller not registered in the address book storage unit may be registered in the caller identification information storage unit included in the terminal, and thereafter the identification information of the corresponding caller is read from the caller identification information storage unit to be provided to the terminal user if a call is received by the corresponding caller again. However, the caller identification information storage unit may be included in a server to share identification information of callers from which no call is directly received. The server may be an intranet or internet server.

In other words, if an incoming call is received from a caller not registered in the address book storage unit, it is determined whether a telephone number of the caller is registered in the caller identification information storage unit of the server. If the caller's telephone number is registered in the caller identification information storage unit of the server, identification information of the corresponding caller is provided from the server to the terminal user. If the caller's telephone number is not registered in the caller identification information storage unit of the server, identification information of the caller that is collected through a voice call may be transmitted to the server to be shared with other users.

According to the caller information providing apparatus and the method of a terminal of the present disclosure, identification information of a caller is automatically collected and stored during a call with the caller not stored in an address book, and the identification information (caller's telephone number, caller contents, keywords, and the like) of the caller that is collected during the previous call is provided as caller information if the a call from the corresponding caller is received again. Therefore, the identification information of the caller not stored in the address book is able to be collected without an additional operation performed by the terminal user, thereby enabling the terminal user to easily select whether to answer the call with the corresponding caller.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to provide caller information, the apparatus comprising:
an address book storage unit to store telephone numbers and names received from a terminal user;
a caller identification information storage unit to store a telephone number of a caller not registered in the address book storage unit, contents of a call with the caller, and a keyword extracted from the call contents;
a voice-text conversion unit to convert the call contents into text;
a keyword extraction unit to extract the keyword by analyzing the converted text; and
a control unit to control the storage of the telephone number, the call contents, and the keywords in the caller identification unit, to control the conversion of the call contents to text and to control the keyword extraction.

2. The apparatus according to claim 1, wherein the call contents are a portion of the call with the caller in which the caller is speaking.

3. The apparatus according to claim 1, wherein the call contents are a specific period of time of the call with the caller.

4. The apparatus according to claim 1, wherein if a telephone number of a caller included in an incoming call is not registered in either of the address book storage unit or the caller identification information storage unit, the control unit stores the telephone number and the contents of the call with the caller in the caller identification information storage unit as the call begins, extracts a keyword by converting the stored call contents into text, and stores the extracted keyword in the caller identification information storage unit in association with the telephone number of the caller.

5. The apparatus according to claim 1, wherein if the telephone number of a caller included in an incoming call is registered in the caller identification information storage unit, the control unit reads the keyword from the identification information storage unit and provides the telephone number and the keyword as the caller information.

6. The apparatus according to claim 5, wherein, if the keyword read from the caller identification information storage unit is displayed on a display unit along with the telephone number of the caller, and if call contents stored in association with the telephone number of the caller exist, the control unit reproduces the call contents as the caller information.

7. The apparatus according to claim 1, wherein if a text message is received and a telephone number of a caller included in the text message is neither stored in the address book storage unit nor in the caller identification information storage unit, the control unit controls the extraction of a keyword from text included in the test message, and the storing of the extracted keyword and the telephone number in the caller identification information storage unit.

8. The apparatus according to claim 7, wherein if the telephone number is stored in the caller identification information storage unit, the control unit provides the keyword and telephone number as the caller information.

9. The apparatus according to claim 1, wherein the control unit reproduces the call contents stored in the caller identification information storage unit according to a request of the terminal user.

10. The apparatus according to claim 1, wherein the control unit periodically updates the caller information stored in the caller identification information storage unit.

11. The apparatus according to claim 1, wherein the call contents is reproduced as a ringtone and the ringtone is reproduced if the apparatus receives a call from the telephone number.

12. A method for providing caller information, the method comprising:
determining whether a telephone number of a caller included in an incoming call is registered in an address book storage unit;
if the telephone number of the caller is not registered in the address book storage unit, determining whether the telephone number of the caller is registered in a caller identification information storage unit;
if the telephone number of the caller is not registered in the caller identification information storage unit, storing a caller identification information of the telephone number of the caller, contents of a call with the caller, and a keyword extracted from the call contents in the caller identification information storage unit; and
if the telephone number of the caller is registered in the caller identification information storage unit, displaying a keyword from the caller identification storage unit on a display unit along with the telephone number of the caller as caller information.

13. The method according to claim 12, wherein the call contents are a portion of the call with the caller in which the caller is speaking.

14. The apparatus according to claim 12, wherein the call contents are a specific period of time of the call with the caller.

15. The apparatus according to claim 12, wherein the call contents is reproduced as a ringtone and the ringtone is reproduced if the apparatus receives a call from the telephone number again.

16. The method according to claim 12, wherein the storing of the caller identification information comprises:
storing the telephone number of the caller and contents of the call with the caller as the call is started;
converting the stored call contents into text;
extracting a keyword from the converted text; and
storing the extracted keyword in the caller identification information storage unit in association with the telephone number of the caller.

17. The method according to claim 12, further comprising:
reproducing the call contents stored in association with the telephone number of the caller as the caller information.

18. The method according to claim 12, further comprising:
if a text message is received, determining whether a telephone number of a caller included in the text message is registered in an address book storage unit;
if the telephone number of the caller is not registered in the address book storage unit, determining whether the telephone number of the caller is registered in a caller identification information storage unit;
if the telephone number of the caller is not registered in the caller identification information storage unit, extracting a keyword from text included in the text message, and storing the extracted keyword in the caller identification information storage unit along with the telephone number of the caller; and
if the telephone number of the caller is registered in the caller identification information storage unit, providing a keyword from the caller identification information storage unit as the caller information.

19. The method according to claim 12, further comprising:
if a telephone number of a caller not registered in the address book storage unit is selected from a call list by a terminal user, reproducing call contents stored in association with the telephone number of the selected caller.

20. A method for providing caller information, the method comprising:
determining if a telephone number of a terminal included in a received data communication is registered in an address book storage unit;
if the telephone number of the terminal is not registered in the address book storage unit, determining whether the telephone number of the terminal is registered in a caller identification information storage unit;
if the telephone number of the terminal is not registered in the caller identification information storage unit, extracting a keyword from the data communication in the caller identification information storage unit; and
if the telephone number of the terminal is registered in the caller identification information storage unit, displaying a keyword from the caller identification storage unit on a display unit along with the telephone number of the terminal as caller information.

21. The method according to claim 20, wherein the data communication is a text message.

22. The method according to claim 20, wherein the data communication is a voice call.

23. An apparatus to provide caller information, the apparatus comprising:
an address book storage unit to store telephone numbers and names received from a terminal;
a caller identification information storage unit to store a telephone number of a terminal not registered in the address book storage unit and a keyword extracted from a data communication;
a keyword extraction unit to extract the keyword by analyzing the data communication; and
a control unit to control the storage of the telephone number and the keywords in the caller identification unit and to control the keyword extraction.

24. The apparatus according to claim 23, wherein if a telephone number of a terminal included the data communication is not registered in either of the address book storage unit or the caller identification information storage unit, the control unit stores the telephone number in the caller identification information storage unit, extracts a keyword from the data communication, and stores the extracted keyword in the caller identification information storage unit in association with the telephone number of the terminal.

25. The apparatus according to claim 23, wherein if the telephone number of a terminal included the data communication is registered in the caller identification information storage unit, the control unit reads the keyword from the identification information storage unit and provides the telephone number and the keyword as the caller information.

26. The apparatus according to claim 23, wherein the data communication is a text message.

27. The apparatus according to claim 23, wherein the data communication is a voice call.
